(19) United States
(12) Patent Application Publication
(10) Pub. No.: US 2009/0278012 A1
(43) Pub. Date: Nov. 12, 2009

(54) Portable tools

(75) Inventors: Yukiyasu Okouchi, Anjo-shi (JP); Shingo Umemura, Anjo-shi (JP); Takayoshi Yoshimura, Anjo-shi (JP); Jiro Oda, Anjo-shi (JP); Kenichi Miyata, Anjo-shi (JP)

Correspondence Address: OLIFF & BERRIDGE, PLC, P.O. BOX 320850, ALEXANDRIA, VA, 22320-4850, US

(73) Assignee: MAKITA CORPORATION, ANJO-SHI (JP)

(21) Appl. No.: 12/453,380

(22) Filed: May 8, 2009

(30) Foreign Application Priority Data
May 9, 2008 (JP) 2008-123709

(51) Int. Cl. F16B 45/00

(52) U.S. Cl. 248/304

(57) ABSTRACT

The present invention includes a portable tool including a tool body having a handle, a hook including a hook body, and a mounting device. The mounting device enables the hook body to be mounted to the handle with the hook body oriented in any one of a plurality of different directions and positioned at any one of a plurality of different positions along the oriented direction.

This application claims priority to Japanese patent application serial number 2008-123709, the contents of which are incorporated herein by reference.

### BACKGROUND OF THE INVENTION

1. Field of the Invention

The present invention relates to portable tools, such as hand-held portable tools including motor-driven tools, such as power screwdrivers, power drills and power tackers, and tools of gas combustion type.

2. Description of the Related Art

A known hand-held portable tool has a hook enabling an operator to engage the hook to his or her belt when the tools are not used. In many cases, the hook is disposed at a position proximal to the rear end of a handle, which is grasped by the operator during the operation of the tool, so that the hook does not interfere with the operation of the tool. There has been proposed various improvements in the hoot For example, Japanese Laid-Open Patent Publication No. 10-15852 has proposed to enable a hook to be selectively mounted to a left side or a right side of a handle. Japanese Laid-Open Patent Publication No. 2001-162566 has proposed to enable adjustment of a distance between a hook and a handle by changing the orientation of the hook on one side of the handle. U.S. Pat. No. 7,306,052 teaches a technique of enabling a hook to be stored within and along a portion of a handle.

However, the technique of Japanese Laid-Open Patent Publication No. 10-15852 does not allow changing the distance between the hook and the handle. The technique of Japanese Laid-Open Patent Publication No. 2001-162566 does not allow changing the position of the hook between positions on the left side and the right side of the handle; The technique of U.S. Pat. No. 7,306,052 does not allow changing the distance between the hook and the handle when the hook is positioned on the right side or the left side of the handle.

Therefore, there is a need in the art for portable tools that have hooks and are improved in operability.

### SUMMARY OF THE INVENTION

One aspect according to the present invention includes a portable tool including a tool body having a handle, a hook including a hook body, and a mounting device. The mounting device enables the hook body to be mounted to the handle with the hook body oriented in any one of a plurality of different directions and with the hook body positioned at any one of a plurality of different positions along the oriented direction.

### BRIEF DESCRIPTION OF THE DRAWINGS

FIG. 1 is a perspective view of a portable tool according to an embodiment of the present invention;

FIG. 2 is a perspective view of a hook having a hook body and a hook holder mounted to a lower end of a handle of the portable tool and showing the state where the hook body is positioned at a left large distance position;

FIG. 3 is a perspective view of the hook body;

FIG. 4 is a perspective view of the hook holder;

FIG. 5 is a perspective view of the hook and showing the state where the hook body is positioned at a left small distance position; and

FIG. 6 is a view as viewed in a direction of arrow (6) in FIG. 2 and shown a left large distance position of the hook body by solid lines, and showing the left small distance position, a right large distance position and a right small distance position of the hook body by chain lines.

### DETAILED DESCRIPTION OF THE INVENTION

Each of the additional features and teachings disclosed above and below may be utilized separately or in conjunction with other features and teachings to provide improved portable tools. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful embodiments of the present teachings.

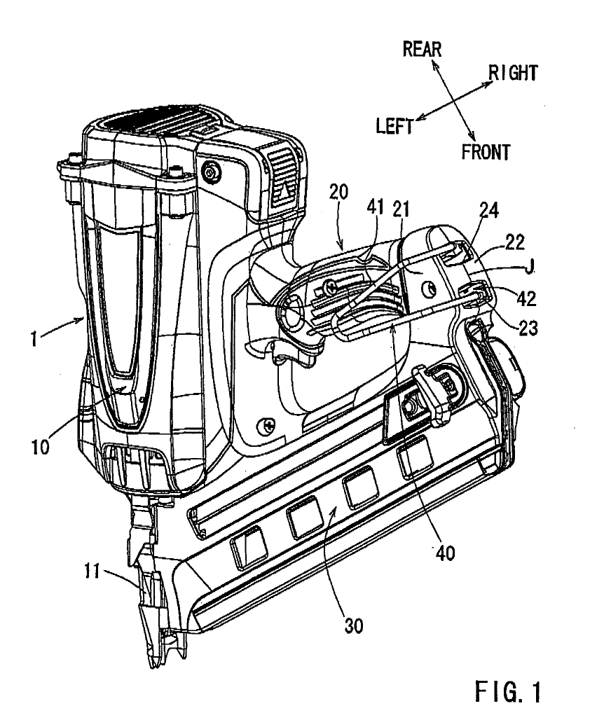

An embodiment of the present invention will now be described with reference to FIGS. 1 to 6. Referring to FIG. 1, there is shown an entire portable tool 1 configured as a nailer of gas combustion type. In the following explanation, a position of a person who may grasp the handle 20 will be taken as a reference of right and left directions, forward and rearward directions and upward and downward directions.

The portable tool 1 has a tool body 10 and a handle 20. A hook 40 has hook holder 42 mounted to a lower end (right end as viewed in FIG. 1) of the handle 20. A driver guide 11 is mounted to a front portion of the tool body 10 and extends forwardly therefrom. A magazine 30 is mounted to the driver guide 11 and a lower portion of the handle 20 and extends therebetween. Nails (not shown) are stored within the magazine 30 and can be supplied one by one into the driver guide 11 in response to the driving operation of the tool body 10, so that the nails can be driven out of the front end of the driver guide 11. More specifically, although not shown in the drawings, the tool body 10 has a piston that is reciprocally movable within a cylinder and can be driven to move forwardly by the pressure of a combusted gas, so that a driver attached to the piston can move forwardly within the driver guide for driving the nail.

The handle 20 is mounted to a lower side of the tool body 10 and extends downwardly therefrom. Each of the tool body 10 and the handle 20 has right and left housing halves. More specifically, the handle 20 has a pair of right and left handle housings halves 21 and 22 that are in contact with each other and are joined at a joint plane J to configure a handle housing that can be easily grasped by an operator. The hook 40 has a hook body 41 and is positioned on the left side of the handle 20 in FIG. 1.

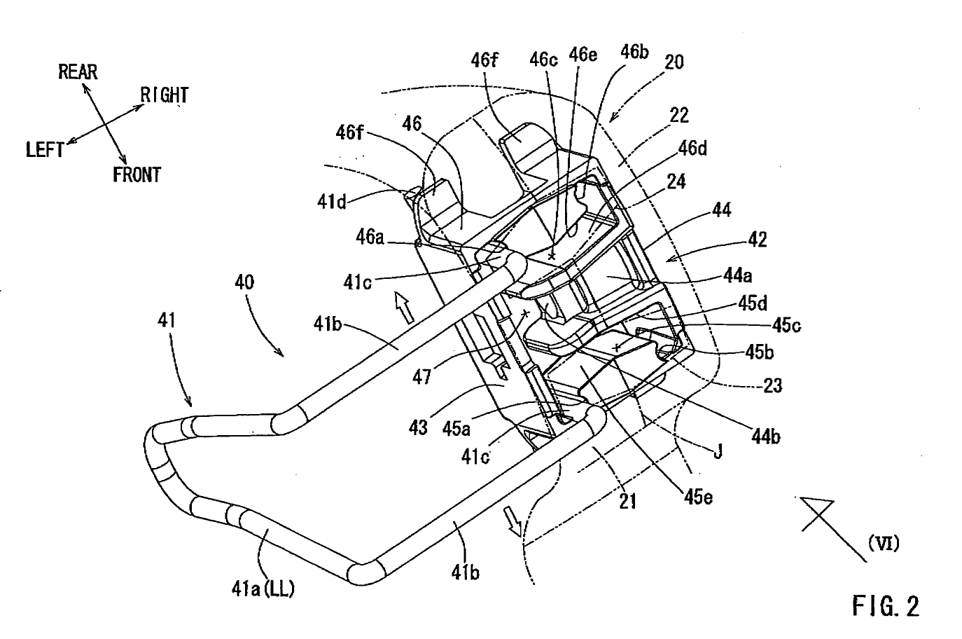

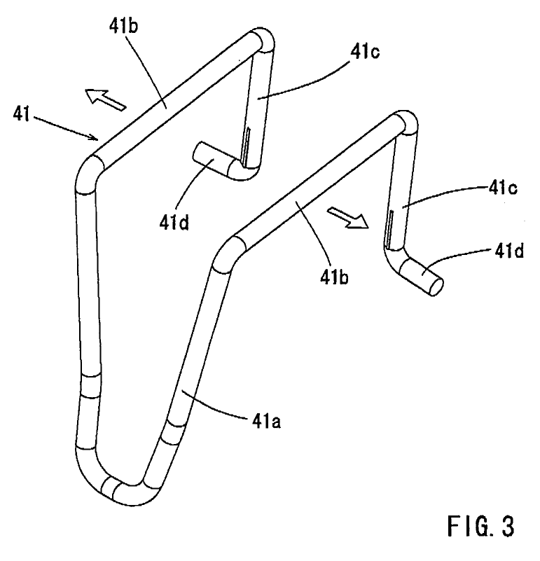

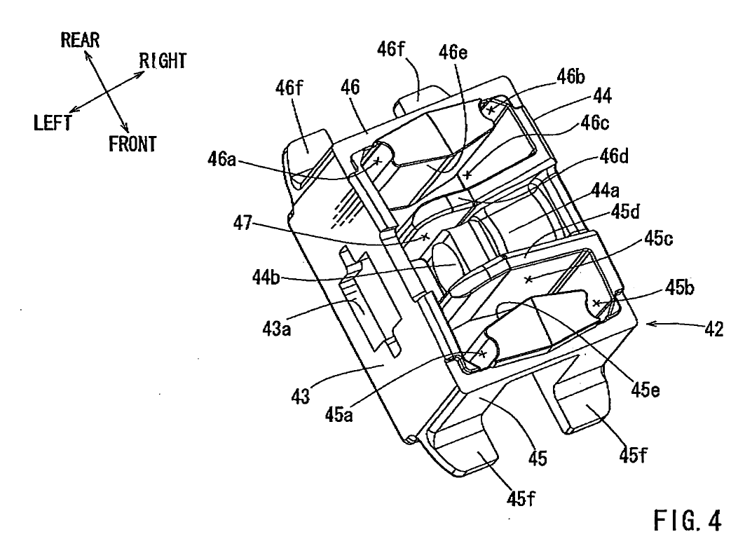

The hook 40 has the hook body 41 and the hook holder 42 for holding the hook body 41 against the handle 20. As shown in FIG. 2, the hook holder 42 is fixed and clamped between the handle housing halves 21 and 22 of the handle 20. The hook body 41 is shown separately in FIG. 3, and the hook holder 42 is shown separately in FIG. 4.

The hook body 41 is formed by a single steel wire and is bent in a form of U-shape, so that the hook body 41 has resiliency. The hook body 41 has a U-shaped hook portion 41a, a pair of extension arms 41b extending rightwardly from the hook portion 41a, and a pair of support legs 41c extending rightwardly from the respective extension arms 41b. More specifically, the extension arms 41b extend in parallel to each other and substantially perpendicular to the opposite end portions of the hook portion 41a The support legs 41c extend substantially perpendicular to the end portions of the extension arms 41b on the side opposite to the hook portion 41a and substantially in parallel to the hook portion 41a The end portions of the support legs 41c on the side opposite to the extension arms 41b are bent in directions away from each other to form engaging portions 41d.

Because the hook portion 41a has a U-shape and has resiliency in open and close directions of the U-shape, the hook body 41 may have resiliency as a whole in such directions that the extension arms 41b are shifted toward and away from each other (e.g., the directions indicated by outline arrows in FIGS. 2 and 4). Therefore, the operator can move the extension arms 41b toward each other against the resiliency by pinching the extension arms 41b with his or her fingers. In other words, the extension arms 41b can be closed by forcibly moving the extension arms 41b toward each other against the biasing force. By closing the extension arms 41b, the support legs 41c are also closed or moved toward each other, and further, the engaging portions 41d are also closed or moved toward each other. Thus, in this embodiment, the support legs 41c can be moved toward each other as the extension arms 41b move toward each other. In addition, by moving the extension arms 41b toward each other, it is possible to change the position of the hook body 41 or to remove the hook body 41 from the hook holder 42 as will be explained later.

The hook holder 42 has a frame-like configuration and formed into one piece with four side walls 43, 44, 45 and 46. More specifically, the hook holder 42 has left and right side walls 43 and 44 opposed to each other and also has front and rear side walls 45 and 46 opposed to each other. A rectangular insertion hole 43a is formed in the central portion of the left side wall 43. A boss portion 44a is formed on the central portion of the inner side of the right side wall 44 at a position opposed to the insertion hole 43a An insertion hole 44b is formed to extend along the central axis of the boss portion 44a. The insertion holes 43a and 44b extend along the same axis. The handle housing halves 21 and 22 have inner wall surfaces having boss portions (not shown) that are substantially closely fitted into the insertions holes 43a and 44b, respectively. Screw insertion holes are formed in the boss portions of the handle housing halves 21 and 22, so that a fixing screw can be inserted into the screw insertion holes. With the hook holder 42 positioned between the handle housing halves 21 and 22 and with the handle housing halves 21 and 22 contacting with each other at the joint plane J, the fixing screw is inserted into the screw insertion holes and is engaged with a nut or an internal thread formed in one of the screw insertion holes. Then, the fixing screw is tightened, so that the handle housing halves 21 and 22 are connected to each other, and at the same time, the hook holder 42 is clamped and fixed between the handle housing halves 21 and 22. In this way, the hook holder 42 can be fixedly mounted within the lower end portion of the handle 20.

Support holes 45a and 45b are formed in the front side wall 45 and are positioned at the right side end and left side end of the front side wall 45, respectively. Similarly, support holes 46a and 46b are formed in the rear side wall 46 and are positioned at the right side end and the left side end of the rear side wall 46, respectively. The support holes 45a, 45b, 46a and 46b extend parallel to each other and have a width capable of substantially closely receiving the support legs 41b of the hook body 41. The hook body 41 can be mounted to the hook holder 42 to extend leftward or rightward from the hook holder 42 with one of the support legs 41c supported within the front side support hole 45a (or 45b), and with the other of the support legs 41c supported within the rear side support hole 46a (or 46b).

The front side support holes 45a and 45b communicate with each other in right and left directions via a connecting recess 45c. The rear side support holes 46a and 46b communicate with each other in right and left directions via a connecting recess 46c, The front side of the front side connecting recess 45c is delimited by a guide wall 45e, and the rear side of the front side connecting recess 45c is delimited by a support wall 45d. Similarly, the front side of the rear side connecting recess 46c is delimited by a support wall 46d, and the rear side of the rear side connecting recess 46c is delimited by a guide wall 46e. The boss portion 44a is positioned between the support walls 45d and 46d.

One of the support legs 41c of the hook body 41 can move between the left and right support holes 45a and 45b via the front side connecting recess 45c. The other of the support legs 41c can move between the left and right support holes 46a and 46b via the rear side connecting recess 46c.

The front side guide wall 45e is formed to have an angle shape that is inclined rearwardly from a central ridge with respect to the right and left directions. Similarly, the rear side guide wall 46e is formed to have an angle shape that is inclined forwardly from a central ridge with respect to the right and left directions. When the support legs 41e of the hook body 41 are resiliently pressed against the guide walls 45e and 46e, respectively, the support legs 41c are guided to move into the left support holes 45a and 46a or the right support holes 45b and 46b due to the inclination of the guide walls 45e and 46e. Therefore, the support legs 41c can be prevented from stopping at midpoints of the corresponding connecting recesses 45c and 46c, respectively, so that the support legs 41c can be held in stable within the left support holes 45a and 46a or within the right support holes 45b and 46b.

Further, because the guide walls 45e and 46e of the connecting recesses 45c and 46c are angled to have central ridges and the support legs 41c are resiliently pressed against the guide walls 45e and 46e, the support legs 41c can be prevented from being removed from the support holes 45a and 46e (or the support holes 45b and 46b). Thus, once the support legs 41c are held within the support holes 45a and 46a (or the support holes 45b and 46b), the support legs 41c are prevented from being removed even in the case that vibrations are applied to the portable tool. Therefore, the hook body 41 can be mounted in stable.

Further, the support walls 45d and 46d extend from the right side wall 44 and terminate at a position before reaching the left side wall 43. With this arrangement, a removing recess 47 for facilitating the removal of the hook body 41 is formed to extend in forward and rearward directions along the left side wall 43 and communicates between the left front side support hole 45a and the left rear side support hole 46a. Thus, in order to remove the hook body 41, the operator pinches the extension arms 41b to move the support legs 41c toward each other against the resilient biasing forces, so that the support legs 41c enter the removing recess 47, where it is possible to move the support legs 41c further toward each other.

Contact walls 45f are formed on the front side wall 45 at positions proximal to the lower ends of the support holes 45a and 45b and extend forwardly therefrom, respectively. Similarly, contact walls 46f are formed on the rear side wall 46 at positions proximal to the lower ends of the support holes 46a and 46b and extend rearwardly therefrom, respectively.

The engaging portions 41d of the hook body 41 can engage the contact walls 45f or 46f from the backside or the lower side (i.e., backside of the sheet of FIG. 2) of the hook holder 42, so that the hook body 41 can be prevented from being removed in a removing direction (i.e., a direction on the front side of the sheet of FIG. 2 or FIG. 4) from the hook holder 42.

As described previously, in order to remove the hook body 41, the operator pinches the extension arms 41b with his or her fingers to move the support legs 41c toward each other against the biasing forces, so that the support legs 41c enter the removing recess 47, where it is possible to move the support legs 41c further toward each other. As the support legs 41c are positioned close to each other after entering the removing recess 47, the engaging portions 41d are moved not to oppose to the contact walls 45f and 46f but to oppose to the support holes 45a and 46a. In this state, the engaging portions 41d and the support legs 41c can be removed upwardly from the support holes 45a and 46a, so that the hook body 41 can be removed from the hook holder 42.

In this way, by using the removing recess 47 disposed at the left side portion of the hook holder 42, the hook body 41 can be removed from the hook holder 42. The hook body 41 can be mounted to the hook holder 42 also by using the removing recess 47. Thus, in order to mount the hook body 41 to the hook holder 42, the hook body 41 is oriented rightward or leftward, and the support legs 41c are then positioned within the removing recess 47. Thereafter, the operator releases the support legs 41c, so that the support legs 41c resiliently restore to move away from each other. Hence, the support legs 41c enter the corresponding support holes 45a and 46a. As a result, the hook body 41 can be mounted such that the hook body 41 is positioned on either the left side or the right side of the handle 20.

The hook holder 42 constructed as described above is fixedly mounted within the lower end of the handle 20 as shown in FIGS. 1 and 2. More specifically, front and rear openings 23 and 24 are formed in the lower end of the handle 20. The front and rear openings 23 and 24 are spaced from each other in the forward and rearward directions and each extends between the left and right handle housing halves 21 and 22 across the joint plane J.

The front connecting recess 45c and the front left and right side support holes 45a and 45b of the hook holder 42 are open to the outside of the handle 20 via the front opening 23. Similarly, the rear connecting recess 46c and the rear left and right side support holes 46a and 46b are open to the outside of the handle 20 via the rear opening 24. The width of each of the openings 23 and 24 in the forward and rearward directions is set to be sufficient for the function of the removing recess 47.

According to the portable tool 1 of the above embodiment, the hook 40 is disposed at the lower end of the handle 20. By using the hook 40, the operator can hook the portable tool 1 to a waste belt that he or she wears or to a foot holding base of a stepladder when the portable tool 1 is not used. Therefore, it is possible to easily handle the portable tool 1 and the operator can efficiently perform various works by using the portable tool 1.

Further, according to the hook 40 of this embodiment, the mounting position of the hook body 41 can be changed between the left side and the right side of the handle 20. In addition, depending on an object, to which the hook 40 is hooked, it is possible to change the distance between the hook portion 41a and the left or right side surface of the handle 20 between a small distance and a large distance in either case that the hook body 41 is positioned on the left side or the right side of the handle 20.

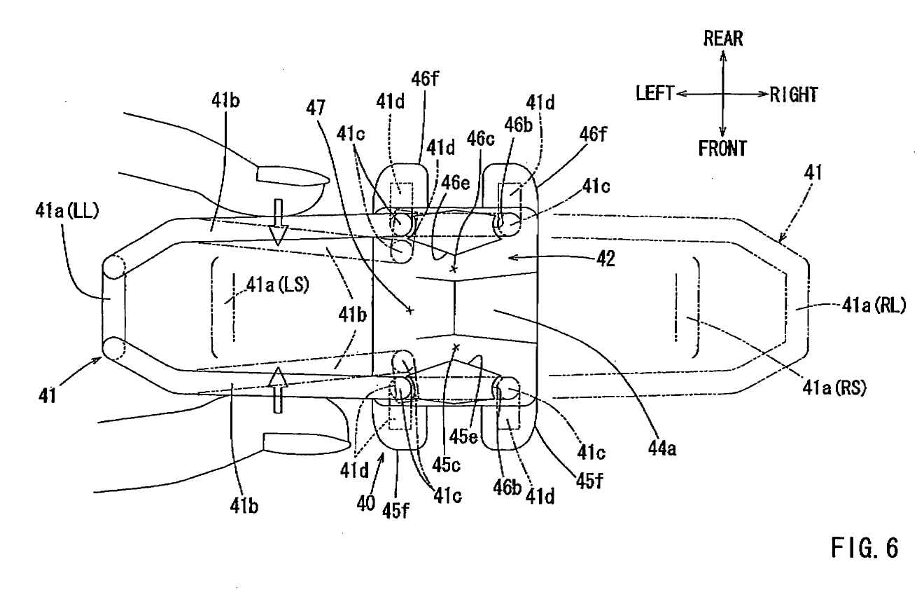

In FIG. 6, the hook body 4 mounted to the left side of the handle 20 is indicated by solid lines, while the hook body 41 mounted to the right side of the handle 20 is indicated by chain lines. In FIG. 6, the hook portion 41a of the hook body 41 indicated by solid lines is positioned at a large distance position spaced from the left side surface (not shown in FIG. 6) of the handle 20 by a large distance and is labeled with an additional reference sign (LL). FIGS. 1 and 2 show the hook body 41 mounted to the left side of the handle 20 at the large distance position.

When the hook body 41 is mounted to the left side at the large distance position (hereinafter called “left large distance position”), the hook portion 41a of the hook body 41 is spaced by a large distance from the left side surface of the handle 20. Therefore, the left large distance position is suitably used, for example, in the case that the portable tool 1 is hooked to a relatively thick member, such as a foot holding base of a stepladder and a two-by-four material. The mounting position of the hook body 41 can be changed from the left large distance position to a small distance position on the left side of the handle 20 (hereinafter called “left small distance position”).

In order to change the mounting position of the hook body 41 from the left large distance position to the left small distance position, it is not necessary to remove the hook body 41 from the hook holder 42 or the handle 20. Thus, the operator first pinches the extension arms 41b of the hook body 41 with his or her fingers to move the extension arms 41b toward each other against the resilient forces of the extension arms 41b as indicated by outline arrows in FIG. 6. As the extension arms 41b move toward each other to positions indicated by chain lines in FIG. 6, the support legs 41C also move toward each other so as to be removed from the support holes 45a and 46b and moved into the connective recesses 45c and 46c. In addition, because the distance between the support legs 41c becomes smaller, the engaging portions 41d formed on the lower sides of the support legs 41c move from positions opposed to the backsides of the corresponding contact walls 45f and 46f of the hook holder 42 to positions within the support holes 45a and 46a or within the connecting recesses 45c and 46c.

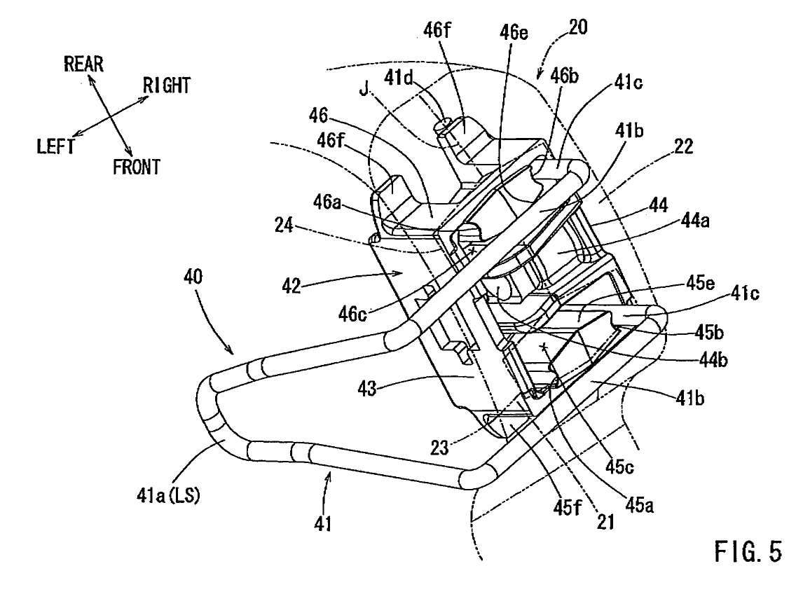

As the engaging portions 45a and 46a move away from the contact walls 45f and 46f, the support legs 41c can move leftward or rightward within the connecting recesses 45c and 46c, so that the hook body 41 can be moved leftward or rightward. For example, when the hook body 41 is moved rightward from the left large distance position indicated by solid lines in FIG. 6, the distance between the hook portion 41a of the hook body 41 and the left side surface of the handle 20 becomes smaller. When the hook body 41 reaches the left small distance position, the operator releases the extension arms 41b, so that the extension arms 41b move away from each other. Then, the support legs 41b are fitted into the support holes 45b and 46b positioned on the right side, and the engaging portions 41d are brought to contact the backsides of the contact walls 45f and 46f positioned on the right side. The hook body 41 can be held in stable at the left small distance position because the support legs 41c are pressed against the inner surfaces of the support holes 45b and 46b by the resilient forces of the support legs 41c. FIG. 5 shows the state where the hook body 41 is held at the left small distance position.

In this way, the distance between the hook portion 41a and the left side surface of the handle 20 becomes smaller as the hook body 41 moves from the left large distance position to the left small distance position. The left small distance position is suitably used when the hook body 41 is hooked to a relatively thin member, such as a waist belt of the operator. In FIGS. 5 and 6, the hook portion 41a of the hook body 41 positioned at the left small distance positioned is labeled with an additional reference sign (LS).

As described above, the hook body 41 can be mounted such that the hook body 41 is positioned at any one of two leftwardly extending positions including the left large distance position and the left small distance position. It is also possible to mount the hook body 41 on the right side of the handle 20. In order to change the position of the hook body 41 from the left large distance position to the right side of the handle 20, the operator pinches the extension arms 41b with his or her fingers to move them toward each other against the resilient forces, so that the support legs 41c move from the support holes 45a and 46b into the removing recess 47. As the support legs 41c move close to each other, the engaging portions 41d move into the removing recess 47 away from positions opposed to the backsides of the contact walls 45f and 46f. Thereafter, the support legs 41c and the engaging portions 41d can be removed from the removing recess 47 and further from the openings 23 and 24. Hence, the book body 41 can be removed from the hook holder 42.

The removed hook body 41 is then reversed with respect to the left and right directions, and the operator again pinches the extension arms 41b to move them toward each other against the biasing forces. With the extension arms 41b held to be close to each other, the operator inserts the support legs 41c into the removing recess 47 via the openings 23 and 24. Thereafter, the operator releases the extension arms 41b, so that the support legs 41c enter the support holes 45a and 46b and the engaging portions 41d engage the backsides of the contact walls 45f and 46f. As a result, the hook body 41 can be mounted at a small distance position that is spaced from the right side surface of the handle 20 by a small distance. This position will be hereinafter called “right small distance position”, and the hook portion 41a of the hook body 41 positioned at the right small distance position is labeled with an additional reference sign (RS) in FIG. 6.

Also, the mounting position of the hook body 41 can be changed from the right small distance position to a large distance position that is spaced from the right side surface of the handle 20 by a large distance (hereinafter called “right large distance position”) in the same manner as discussed in connection with the left small and large distance positions. Thus, the operator first pinches the extension arms 41b of the hook body 41 with his or her fingers to move the extension arms 41b toward each other against the resilient forces of the extension arms 41b. Then, the operator moves the hook body 41 rightward to move the support legs 41c along and within the connecting recesses 45c and 46c. This operation can be made while the support legs 41c slidably contact with the corresponding guide walls 45e and 46d by the biasing forces of the extension arms 41b. When the hook body 41 reaches the right large distance position, the support legs 41b are fitted into the support holes 45b and 46b positioned on the right side, and the engaging portions 41d are brought to engage the backsides of the contact walls 45f and 46f positioned on the right side. In FIG. 6, the hook portion 41a of the hook body 41 positioned at the right large distance position is labeled with an additional reference sign (RL).

Therefore, similar to the case that the hook body 41 is mounted on the left side of the handle 20, the right large distance position (RL) can be used for hooking the hook body 41 to a foot holding base of a stepladder and a two-by-four material, and the right small distance position (RS) can be used for hooking the hook body 41 to a waste belt worn by the operator.

As described above, according to the above embodiment, the orientation of the hook body 41 relative to the lower end of the handle 20 can be easily changed between the left side position and the right side position. In addition, in each of the left and right side positions, the distance between the hook portion 41a and the corresponding side surface of the handle 20 can be changed between the small distance and the large distance.

Therefore, the operator can use the hook 40 by positioning the hook body 41 at the right side position or the left side position depending on the operator's dominant arm. In addition, the distance between the hook portion 41a and the corresponding side surface of the handle 20 can be changed between two different distances depending on a portion or a member, to which the hook portion 41a is hooked. As a result, the operability of the hook 40 can be improved.

In addition, because the hook body 41 is held in these positions by using the resiliency of the hook body 41, it is possible to easily directly mount the hook body 41 to the hook holder 42 without use of fixing screws or the like.

The above embodiment can be modified in various ways. For example, although the hook holder 42 is formed as a separate member from the handle housing halves 21 and 22, the hook holder 42 may be formed integrally with one or both of the handle housing halves 21 and 22. For example, the hook holder 42 may include a left holder half and a right holder half that are formed integrally with the left handle housing half 21 and the right handle housing half 22, respectively, and are joined to each other at the joint plane J. Alternatively, the entire hook holder 42 may be formed integrally with one of the handle housing halves 21 and 22.

Further, although the guide wall 45e and the guide wall 46e delimiting the front side of the connecting recess 45c and the rear side of the connecting recess 46c, respectively, are each angled to have the central ridge with respect the left and right directions and the inclined surfaces on opposite sides of the central ridge, the guide walls 45e and 46e may be configured as flat surfaces similar to the support walls 45d and 46d opposed thereto, respectively.

Furthermore, although the removing recess 47 is formed in the left side portion of the hook holder 42 for enabling the support legs 41c positioned on the left large distance position (LL) or the right small distance position (RS) to be directly removed by pinching the extension arms 41b, the removing recess 47 can be formed in the right side portion of the hook holder 42, so that the support legs 41c positioned on the left small distance position (LS) or the right large distance position (RL) can be directly removed by pinching the extension arms 41b. Alternatively, an additional removing recess may be formed in the right side portion of the hook holder 42, so that the hook body 41 can be directly removed from the hook holder 42 in either cases that the support legs 41c are positioned on the left side or the right side. With this arrangement, it is also possible to directly mount the hook body 41 at either the left side position or the right side position.

Furthermore, although the nailer of gas combustion type has been described as an example of the portable tool, the present invention can be also applied to pneumatically driven nailers or motor driven nailers. In addition, the present invention may be also applied to screwdrivers and drills or any other portable tools other than the nailers.

This invention claims:

1. A portable tool comprising:
a tool body having a handle; and
a hook including:
a hook holder disposed at the handle; and
a hook body attachable to the hook holder;
wherein the hook body can be attached to the hook holder so as to be positioned on any one of two opposite sides with respect to the handle; and
wherein a distance between the hook body and the handle can be changed in each of the case that the hook body is positioned on one of the two opposite sides and the case that the hook body is positioned on the other of the two opposite sides.

2. The portable tool as in claim 1, wherein:
the hook body includes a pair of support legs and has resiliency in opening and closing directions of the support legs,
the hook body can be attached to the hook holder with the support legs opened to resiliently engage the hook holder; and
the hook body can be removed from the hook holder when the support legs are closed against a resilient force.

3. The portable tool as in claim 1, wherein:
the hook holder includes two pairs of support holes, each pair of the support holes being able to receive the support legs when the support legs are closed against the resilient force;
the support legs can resiliently engage circumferential edges of the support holes when the hook holder resiliently recovers to open the support legs;
the support legs can be selectively inserted into one of the two pairs of support holes, so that the orientation of the hook body relative to the handle and the distance between the hook body and the handle can be selectively changed.

4. The portable tool as in claim 3, wherein the support holes in one of the two pairs are connected to the support holes in the other of the two pairs via a pair of connecting recesses, and the connecting recesses permit passage of the support legs when the support legs are closed, and the connecting recesses do not permit passage of the support legs when the support legs are opened.

5. The portable tool as in claim 4, wherein the handle comprises a pair of handle housing halves that are joined to each other, and wherein the hook holder is clamped between the handle housing halves.

6. A portable tool comprising:
a tool body having a handle;
a hook including a hook body; and
a mounting device configured to be able to detachably mount the hook body to the handle with the hook body oriented in any one of a plurality of different directions and with the hook body positioned at any one of a plurality of different positions along the oriented direction.

7. The portable tool as in claim 6, wherein the different directions include at least a first direction and a second direction opposite to each other.

8. The portable tool as in claim 7, wherein the different positions include at least a first position and a second position along the first direction or the second direction.

9. The portable tool as in claim 6, wherein the mounting device comprises a hook holder attached to the handle.

10. The portable tool as in claim 9, wherein the handle comprises a handle housing, and the hook holder is disposed within the handle housing.

11. The portable tool as in claim 10, wherein the handle housing comprises a first housing half and a second housing half, and the hook holder is clamped between the first and second handle housing halves.

12. The portable tool as in claim 9, wherein the hook body has a pair of legs and is resiliently deformable to change a distance between the legs.

13. The portable tool as in claim 12, wherein:
the hook bolder includes a first pair of support holes and a second pair of support holes spaced from the first pair of support holes; and
each of the first pair and the second pair of support holes are configured to be able to receive the legs of the hook body.

14. The portable tool as in claim 13, wherein
the hook holder further includes connecting recesses connecting between the support holes of the first pair and the support holes of the second pair, so that the legs of the hook body can move between the support holes of the first pair and the support holes of the second pair along the connecting recesses.

15. The portable tool as in claim 14, wherein:
the hook body further includes engaging portions extending from the legs, respectively,
the hook holder further includes:
a first pair of contact walls capable of contacting the engaging portions for preventing the legs from being removed from the support holes in a first direction when the legs are inserted into the support holes of the first pair;
a second pair of contact walls capable of contacting the engaging portions for preventing the legs from being removed from the support holes in the first direction when the legs are inserted into the support holes of the second pair, and
a removing recess connecting between the support holes of the first pair,
wherein the legs of the hook body can move from the support holes of the first pair to the removing recess in a second direction substantially perpendicular to the first direction, so that the engaging portions can be positioned not to oppose to the first pair of contact walls in the first direction.
